(19) United States
(12) Patent Application Publication
(10) Pub. No.: US 2009/0307768 A1
(43) Pub. Date: Dec. 10, 2009

(54) PASSWORD INPUT SYSTEM AND METHOD

(75) Inventors: YU ZHANG, Shenzhen City (CN); TAY-YANG LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/477,112

(22) Filed: Jun. 2, 2009

(30) Foreign Application Priority Data
Jun. 10, 2008 (CN) 200810302080.0

(51) Int. Cl. G06F 12/14; G06F 3/041; G06F 3/033

(52) U.S. Cl. 726/19; 345/173; 715/863

(57) ABSTRACT

A password input system includes a touch screen, a storing module, and an authentication module. The touch screen is capable of displaying a number of symbols, and is used for inputting a password by drawing a line group between the symbols on the touch screen, the line group includes one or more lines. The storing module stores a password consisting of characteristics of a preset line group. The authentication module is capable of comparing the characteristics of the line group drawn on the touch screen with the characteristics of the preset line group stored in the storing module, and allowing or denying a user's access to a main system by judging whether the characteristics of the line group drawn on the touch screen is matched with the characteristics of the preset line group stored in the storing module.

### BACKGROUND

1. Technical Field

The present disclosure relates to passwords and, particularly, to a password input system and a password input method using a touch screen.

2. Description of Related Art

Generally, electronic information is protected by the use of passwords. Thus, gaining access to the information can only be done by correctly inputting the passwords. A typical password is usually consisting of alphanumeric characteristics. The password is usually inputted by pressing a number of keys. Because the position of the keys on a typical keyboard is fixed, passwords can easily be shouldered surfed or even observed from a distance when inputting the password.

What is needed, therefore, is a password input system and a password input method to overcome or mitigate the above-described shortcomings.

### BRIEF DESCRIPTION OF THE DRAWINGS

Many aspects of the present password input system and method can be better understood with reference to the accompanying drawings. The components in the drawings are not necessarily drawn to scale, the emphasis instead being placed upon clearly illustrating the principles of the present password input system and method.

FIG. 1 is a block diagram of a password input system according to an exemplary embodiment.

FIG. 2-6 are schematic diagrams showing password input interfaces generated by the system of FIG. 1

FIG. 7 is a flowchart of a password input method according to an exemplary embodiment.

### DETAILED DESCRIPTION

Embodiments of the present disclosure will now be described in detail below, with reference to the accompanying drawings.

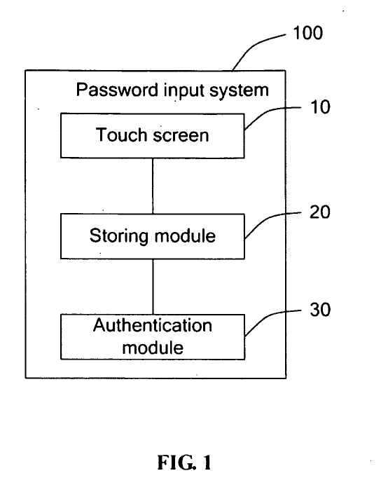

Referring to FIG. 1, a password input system 100 for an electronic device (not shown), according to an exemplary embodiment, is shown. The password input system 100 includes a touch screen 10, a storing module 20, and an authentication module 30.

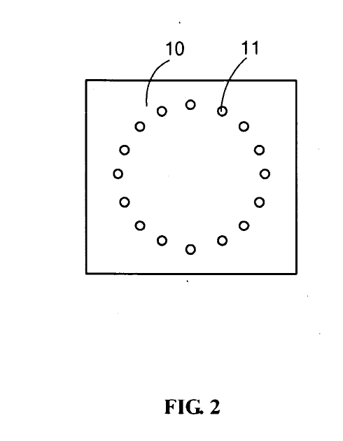

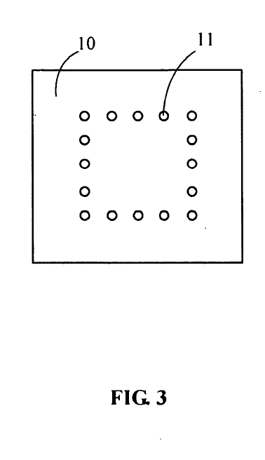

The touch screen 10 can be used to display words, graphics etc., and receive inputs or physical contacts from a user's finger and/or stylus. The inputs or physical contacts between the touch screen 10 and the user's finger and/or stylus are converted to electrical signals. Referring to FIG. 2, during a process of password inputting, the touch screen 10 will display a number of symbols 11. In the present embodiment, the symbols 11 are circles. The positions of the symbols 11 can be arranged as desired. In the present embodiment, the symbols 11 are arranged in a circular manner. In other embodiments, the symbols 11 can also be arranged in a rectangular manner (see FIG. 3).

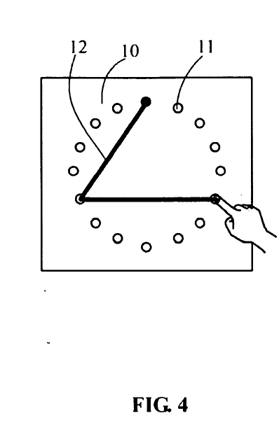

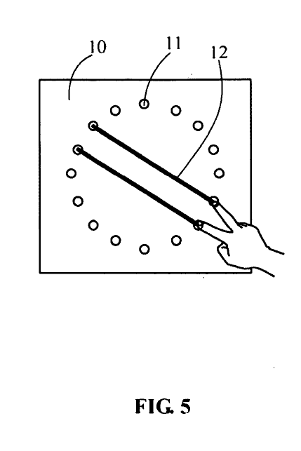

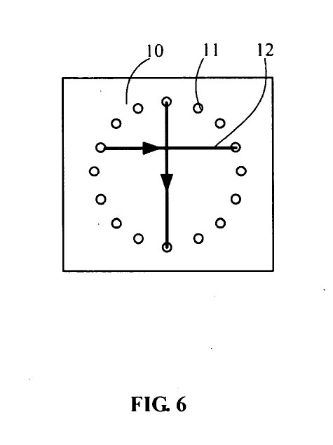

Referring to FIG. 4 to FIG. 6, users can input password by drawing a line or lines between the symbols 11 on the touch screen 10. The line or lines can be classified as a line group wherein the group includes at least one line 12. Each line 12 connects two symbols 11. The line 12 can be drawn on the touch screen 10 by moving fingers or styluses etc. on the touch screen 10. In the present embodiment, each line group includes a number of lines 12. The characteristics of the line group are used as password. The characteristics of the line group can be selected from the group consisting of the number of the lines 12 of the line group, the start point and end point of each line 12, and the drawing sequence of the lines 12. The lines 12 can be drawn continuously by a finger or a stylus (see FIG. 4). The lines 12 can also be drawn simultaneously by two fingers (see FIG. 5). The lines 12 can further be drawn alternately (see FIG. 6). Preferably, the lines 12 are not displayed on the touch screen 10, therefore, the password would be more difficult to be observed by a third party in the process of inputting the password.

The storing module 20 is configured for storing a password which is consisting of characteristics of a preset line group. In the present embodiment, the password is consisting of the number of the lines 12 of the preset line group, the start point and end point of each line 12 of the preset line group, and the drawing sequence of the lines 12 of the preset line group.

The authentication module 30 can compare the characteristics of the line group drawn on the touch screen 10 with the password stored in the storing module 20, and allow or deny a user's access to a main system by judging whether the characteristics of the line group drawn on the touch screen 10 is matched with the characteristics of the preset line group stored in the storing module 20.

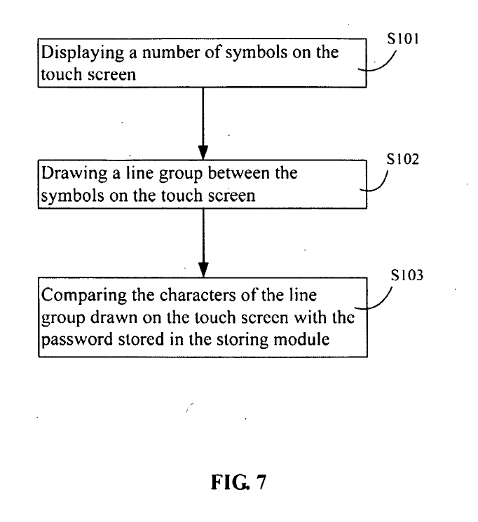

Referring to FIG. 7, a flowchart illustrating a password input method is shown. The password input method includes the following steps.

Step S101: displaying a number of symbols 11 on the touch screen 10. In the present embodiment, the symbols 11 are circles. The positions of the symbols 11 can be arranged as desired. In the present embodiment, the symbols 11 are arranged in a circular manner.

Step S102: drawing a line group between the symbols 11 on the touch screen 10. The line group includes at least one line. Each line 12 connects two symbols 11. The line 12 can be drawn on the touch screen 10 by moving fingers or styluses etc. on the touch screen 10.

Step S103: comparing the characteristics of the line group drawn on the touch screen 10 with the password consisting of the characteristics of the preset line group stored in the storing module 20, and allowing or denying a user's access to a main system by judging whether the characteristics of the line group drawn on the touch screen 10 is matched with the characteristics of the preset line group stored in the storing module 20.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A password input system comprising:
a touch screen capable of displaying a plurality of symbols, and used for inputting a password by drawing a line group between the symbols on the touch screen, the line group comprising one or more lines;
a storing module storing a password consisting of characteristics of a preset line group; and
an authentication module capable of comparing the characteristics of the line group drawn on the touch screen with the characteristics of the preset line group stored in the storing module, and allowing or denying a user's access to a main system by judging whether the characteristics of the line group drawn on the touch screen is matched with the characteristics of the preset line group stored in the storing module.

2. The password input system as claimed in claim 1, wherein the line group is drawn on the touch screen by user's fingers and/or styluses.

3. The password input system as claimed in claim 1, wherein the symbols displayed on the touch screen are arranged in a circular manner.

4. The password input system as claimed in claim 1, wherein the symbols displayed on the touch screen are arranged in a rectangular manner.

5. The password input system as claimed in claim 1, wherein each line of the line group connects two symbols.

6. The password input system as claimed in claim 1, wherein the characteristics of the line group are selected from the group consisting of the number of the lines of the line group, the start point and end point of each line of the line group, and the drawing sequence of the lines of the line group.

7. The password input system as claimed in claim 1, wherein the lines are drawn continuously by a finger or a stylus.

8. The password input system as claimed in claim 1, wherein the lines are drawn simultaneously by two or more fingers or styluses.

9. The password input system as claimed in claim 1, wherein the lines are drawn alternately.

10. The password input system as claimed in claim 1, wherein the lines are not displayed on the touch screen.

11. The password input system as claimed in claim 1, wherein the symbols are circles.

12. A password input method for an electronic device with a touch screen and a storing module, the password input method comprising:
displaying a plurality of symbols on the touch screen;
drawing a line group comprising one or more lines between the symbols on the touch screen; and
comparing the characteristics of the line group drawn on the touch screen with a password consisting of the characteristics of a preset line group stored in the storing module, and allowing or denying a user's access to a main system by judging whether the characteristics of the line group drawn on the touch screen is matched with the characteristics of the preset line group stored in the storing module.

13. The password input method as claimed in claim 12, wherein the line group is drawn on the touch screen by user's fingers and/or styluses.

14. The password input method as claimed in claim 12, wherein the symbols displayed on the touch screen are arranged in a circular manner.

15. The password input method as claimed in claim 12, wherein the symbols displayed on the touch screen are arranged in a rectangular manner.

16. The password input method as claimed in claim 12, wherein each line of the line group connects two symbols.

17. The password input method as claimed in claim 12, wherein the characteristics of the line group are selected from the group consisting of the number of the lines of the line group, the start point and end point of each line of the line group, and the drawing sequence of the lines of the line group.

18. The password input method as claimed in claim 12, wherein the lines are drawn continuously by a finger or a stylus.

19. The password input method as claimed in claim 12, wherein the lines are drawn simultaneously by two or more fingers or styluses.

20. The password input method as claimed in claim 12, wherein the lines are not displayed on the touch screen.
